(19) United States
(12) Patent Application Publication
(10) Pub. No.: US 2017/0357996 A1
(43) Pub. Date: Dec. 14, 2017

(54) SOFTWARE PLATFORM COUPLED TO A PROGRAMMABLE INTERFACE CONTROLLER FOR INTEGRATING SERVICE OFFERINGS

(71) Applicant: Jeffrey Stewart Jones, Duluth, GA (US)

(72) Inventor: Jeffrey Stewart Jones, Duluth, GA (US)

(21) Appl. No.: 15/612,306

(22) Filed: Jun. 2, 2017

Related U.S. Application Data
(60) Provisional application No. 62/349,419, filed on Jun. 13, 2016.

(51) Int. Cl. G06Q 30/02; G06Q 20/20; G06Q 20/18

(52) U.S. Cl. CPC G06Q 30/0237; G06Q 30/0238; G06Q 20/18; G06Q 20/20

(57) ABSTRACT

A platform software system enabling service station operators of unattended self-service devices to couple any number of self-service devices to a plurality of a point of sale station, regardless of the manufacture, without having to purchase additional integration hardware or incur customized development expenses. The system enables the operator to set promotions applicable to each self-service device in the form of tokens or configurable credit.

### CROSS-REFERENCE TO RELATED APPLICATION

This application claims the benefit of priority of U.S. provisional application number 62/349,419, filed 13 Jun. 2016, the contents of which are herein incorporated by reference.

### BACKGROUND OF THE INVENTION

The present invention relates to point of sale (POS) systems and, more particularly, to a POS system adapted to integrate any number of electronic devices, wherein the POS system embodies an interface control system through which promotion creation, modification and digital credit distribution can be incorporated in the POS system.

POS systems are built on proprietary platforms, making the integration to a variety of unique service devices/offerings challenging without a licensee/vendor having to develop program code and incurring other development costs for each device integration point. As a result, this makes it difficult for individual site operators to easily create a variety of value-added point-of-sale promotion offerings for their customers in order to drive competitive differentiation and higher average revenues per good or service at unattended operator sites, which may be open 24 hours a day.

Current POS system solutions provide a single interface to a specific vendor offering (e.g., dispensing tokens based on a certain package selected) making it more difficult and costly to integrate with other devices (e.g., other service or product vendor devices) during the POS purchase transaction. Furthermore, there are currently limited alternatives for providing flexible service or product vendor-related promotions at unattended operator sites. Tokens are a popular option. However, they are costly as they always have to be replenished.

From a digital perspective, current loyalty apps are based on e-commerce platforms that require the customer to download an app first and use a card to transact purchases to earn any promotion credits. This creates an inconvenience for the customer if they are at the POS system and don't have the app or if the customer wants to use cash. Furthermore, the owner-operator must not only have an internet connection, but also utilize a payment gateway to transact payments and place card readers on participating devices, which can add incremental capital and recurring cost.

As can be seen, there is a need for a platform software solution enabling operators to couple any number of devices with their POS system, regardless of the manufacture, without having to purchase additional integration hardware or incur customized development expenses. Furthermore, the platform software solution provides configurable digital credits and digital distribution of promotions and credits to other on premise devices (i.e., through Promotion Identification Codes, PICs), wherein the platform software solution enables selective creation of a plurality of promotional and credit offerings; for example, in the car wash industry, variable time based services like basic and extended service vacuum times, unlimited services (vacuums) for a specified number of hours or days, real time presentation of a discount/free service (e.g., car wash code) for an upgraded service to be used for the customer's current visit, discounts or free car care products, etc.

This digital platform solution doesn't require the customer to download an app in advance (market push through model) or restrict them to only using a card vs. a card or cash to earn promotion credits. In addition, this solution enables the operator to gain customer profile information (e.g., phone number, e-mail, service purchased, etc.) at time of transaction at the POS system when they opt-in. Thus, allowing operators of unattended sites to build a customer contact database at the point of sale while allowing the customer to download an app at a later time to manage their promotion credits if desired (transaction pull through model).

The platform software solution provides operators with a standard device-independent user programmable interface controller platform accessible via a mobile device or Internet, which is connected to a POS pay station and associated service (e.g., vacuums) and product (e.g., car care dispensers) vendors. The present invention may be adapted to interface with the token mechanisms of a multitude of car wash service and product dispensing devices through a wired or wireless platform for the purpose of controlling their outputs based on the wash package selected from an automatic car wash pay station or the total time purchased from a self-serve car wash pay station. The wired platform utilizes tokens, while the wireless platform leverages Promotion Identification Codes (PICs) to distribute earned promotions.

Thereby, easily providing the operator the ability to quickly create unique promotion offerings adapted to the local competitive market conditions across multiple product and/or service devices, while eliminating the need for the operator to develop expensive programs and interfaces for each device. Furthermore, where an operator would typically use tokens as a form of loose integration to run promotions, this solution also leverages the digital distribution of configurable credits to targeted devices, further reducing cost and simplifying operations.

### SUMMARY OF THE INVENTION

In one aspect of the present invention, a system for controlling an unattended service station having at least one self-service devices includes each self-service device having a keypad to input at least one PIC; and a database for storing a plurality of PICs, wherein each sea-service device is configured to initiate upon matching an inputted PIC with a stored PIC; at least one pay station coupled to each self-service device, the at least one pay station configured to generate PICs and to prompt a consumer for at least one received qualification through a display and digitally via their smart device; and a programmable interface coupled to the at least one pay station, wherein the programmable interface prompts a user to set at least one promotion and associate at least one predetermined qualification and at least one self-service device of the at least one self-service devices with each promotion, wherein each pay station is configured to transmit a PIC to each self-service device associated with each matched promotion of the at least one promotion that is associated with said at least one predetermined qualification matching the at least one received qualification.

In another aspect of the present invention, the system for controlling an unattended service station having a plurality of self-service devices includes at least one token self-service device configured to receive a predetermined number of tokens prior to initiation; at least one digital self-service devices having: a keypad to input at least one PIC; and a database for storing a plurality of PICs, wherein each self-service device is configured to initiate upon matching an inputted PIC with a stored PIC; a plurality of pay stations coupled to each self-service device, each pay station configured to prompt a consumer for at least one received qualification through a display and digitally via their smart device; each pay station configured to either to generate PICs or dispense tokens through an attached token hopper; and a programmable interface coupled to each pay station, wherein the programmable interface prompts a user to set at least one promotion and associate at least two of: at least one predetermined qualification; at least one self-service device of the plurality of self-service devices with each promotion; and a predetermined number of tokens to be dispensed through the token hopper for each matched promotion, wherein the programmable interface is coupled to each digital self-service devices for transmitting a PIC thereto during a customer issue, and wherein each pay station generating PICs is configured to transmit each PIC to each digital self-service device associated with each matched promotion of the at least one promotion that is associated with said at least one predetermined qualification matching the at least one received qualification, and wherein the plurality of self-service devices is configured to transmit inputted PIC to the programmable interface for deactivation.

These and other features, aspects and advantages of the present invention will become better understood with reference to the following drawings, description and claims.

### BRIEF DESCRIPTION OF THE DRAWINGS

FIG. 1 is a schematic of an exemplary embodiment of the present invention;

FIG. 2 is a schematic view of an exemplary embodiment of the present invention;

FIG. 3 is a flow chart of an exemplary embodiment of the present invention; and

FIG. 4 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a platform software system enabling service station operators of unattended self-service devices to couple any number of self-service devices to a plurality of a point of sale station, regardless of the manufacture, without having to purchase additional integration hardware or incur customized development expenses. The system enables the operator to set promotions applicable to each self-service device in the form of tokens or configurable credit.

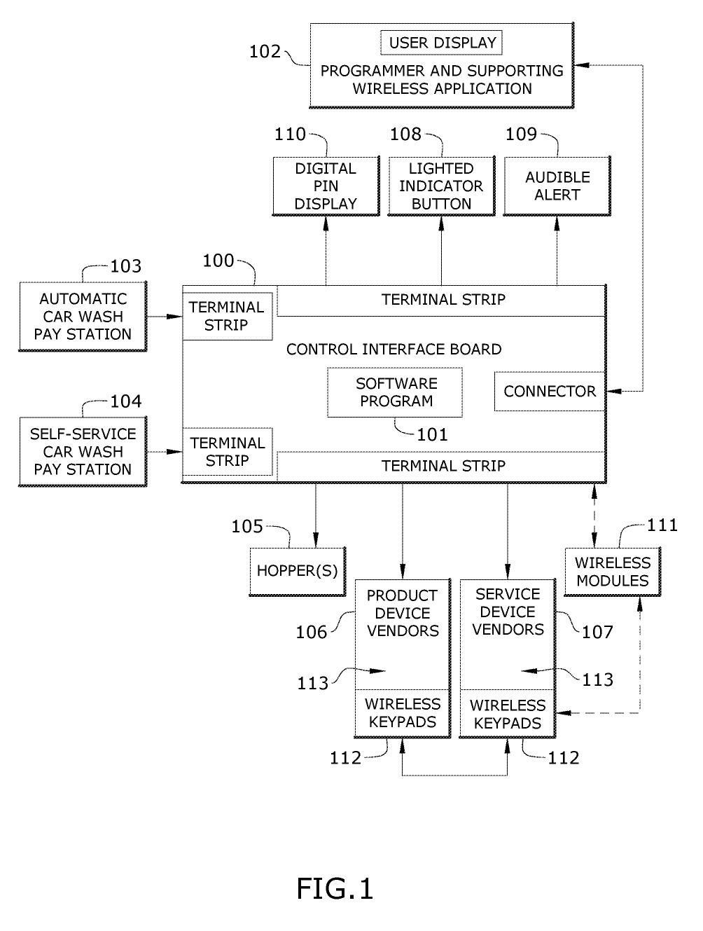

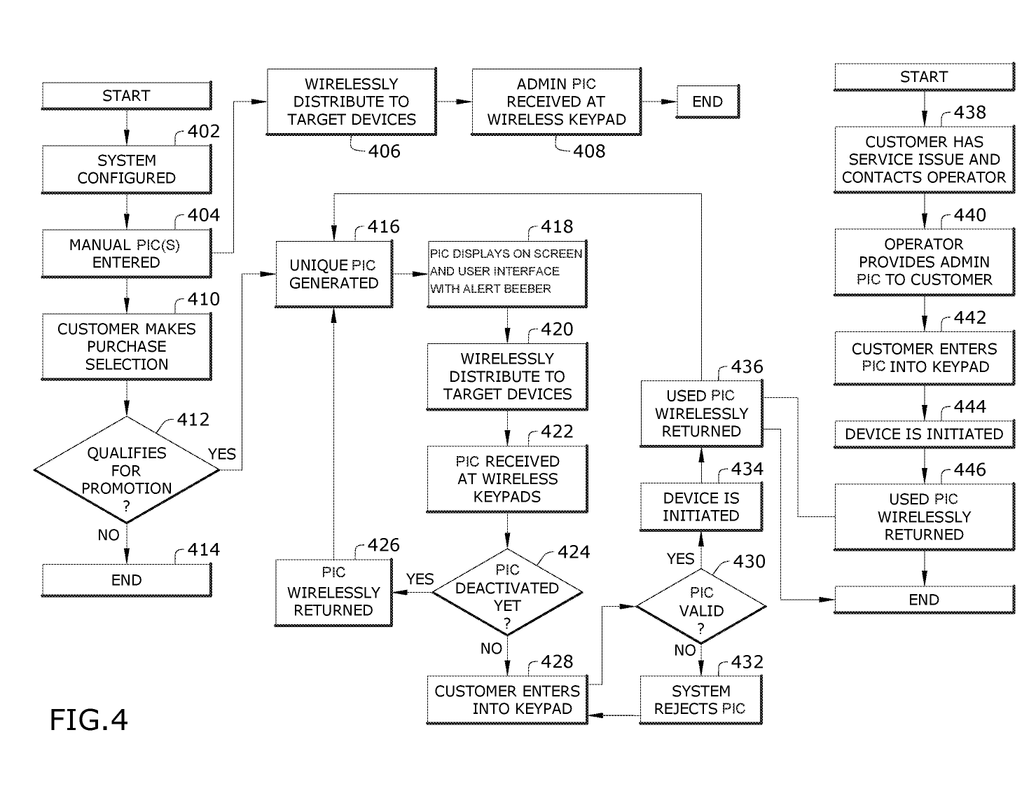

Referring to FIGS. 1 through 4, the present invention may include at least one computer with a user control interface 100. The computer may include at least one processing unit and a form of memory. The computer may include, but not limited to, a desktop, laptop, and smart device, such as, a tablet and smart phone. The computer includes a program product including a machine-readable program code for causing, when executed, the computer to perform steps. The program product may include software 101 which may either be loaded onto the computer or accessed by the computer. The loaded software 101 may include an application on a smart device. The software 101 may be accessed by the computer using a web browser. The computer may access the software 101 via the web browser using the Internet, extranet, intranet, host server, Internet cloud and the like.

The computer may be coupled to a programmable interface 102 having a user display and supporting wireless application. The computer may be coupled to at least one automatic POS pay station 103 and at least one self-service pay station 104. The computer may provide a digital PIC display 110, a lighted indicator button 108, and an audible alert 109. The computer couples to the POS system's service/goods contacts in such a way that contact closure inputs can be sensed by the programmable interface 102 control board when the respective service or good is purchased or time is purchased and processed according to the operation of the program as described herein. The computer may be coupled to a token hopper 105, a product device and service device vendors 106 and 107, respectively, wherein each vendor has a vendor token mechanism 113 and provides a wireless module and keypad 111 and 112 connection to the computer. The computer(s) may be coupled through a wireless computing environment.

It should be understood that although the following disclosure and coordinated figures use the car washing business in an exemplary explanation of how to make and use the present invention, the present invention is in fact applicable to various businesses and organization delivering goods and/or services using an unattended or limited attended business models (e.g., vending machines, kiosks, laundromats, parking facilities, lockers-storage facilities, gas station pumps, etc.).

Referring specifically to FIG. 1, through the programmable interface 101, the operator would enable the functionality required for the devices/vendors being used. This may require entering a code to unlock the specific program functionality required. The operator would then program the number of credits and/or tokens to be triggered based on a customer selection from a plurality of qualified package offerings and promotions. Other operational features, like cancelation credits or time would be programmed by the operator as well. Furthermore, for digital configurable credits the operator could set global parameters to facilitate the creation, distribution and maintenance of PICs to ensure they are deactivated and deleted at desired intervals. The software program 101 may be uploaded to the programmable interface 102 after being simulated, enabling the system embodied by the present invention.

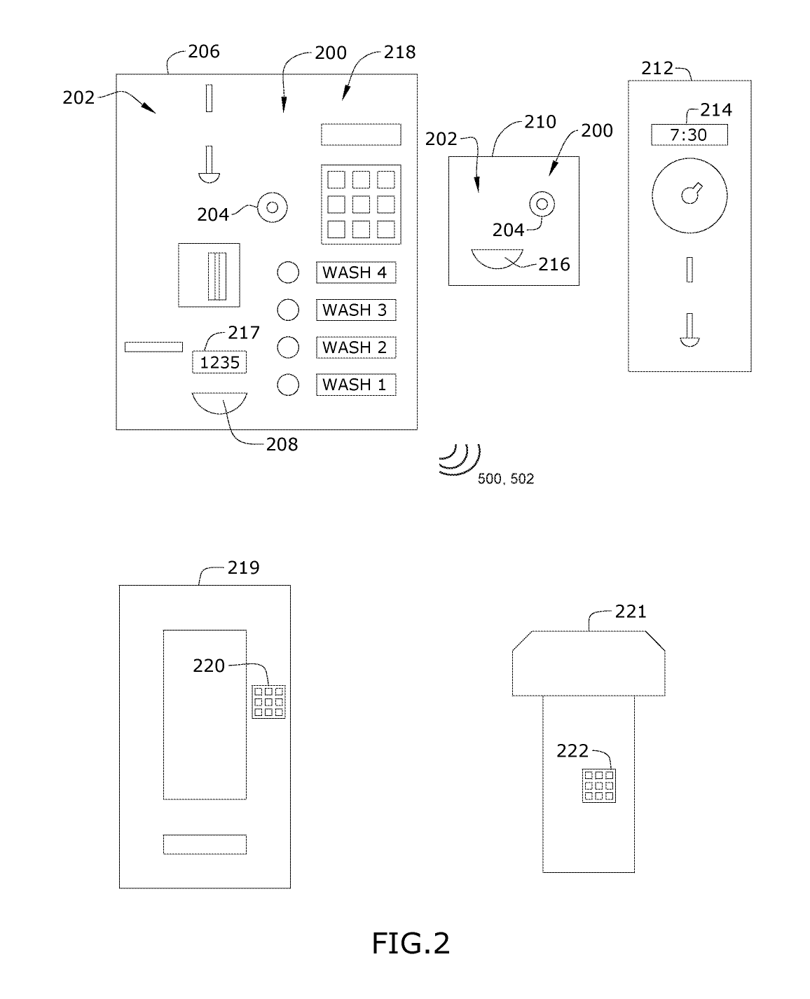

Referring generally to FIG. 2, for the automatic car wash pay station 103/206, the token hopper 105/202 and the programmable interface 102 control board 200 may be mounted inside the pay station 103/206. The lighted indicator button 108/204 may be mounted to the face of the car wash pay station 206. This lighted button 108/204 may only become active if the service wash they selected is promotion eligible. If the customer does qualify, when the lighted button 108/204 is depressed, the hopper 105/202 will dispense the token to the coin tray 208.

The functionality for a self-service pay station 104/212 may be very similar. The difference is the self-serve pay station 104/212 interface would be based on time 214 purchased by the customer. When the customer qualifies for a promotion, they would depress the lighted button 108/204 and the token hopper 105/202, interfaced to the programmable interface/control board 102/200 would dispense the tokens to the coin tray 216.

Prior to every transaction, the system will check to see if it's operational for the next customer. If it is not, the lighted button will start blinking rapidly, indicating to the operator that a service condition exists. The operator would then attempt to fix the service condition and, when corrected, the lighted button stops blinking. At this point the system is ready for the next customer. For the digital channel and configurable credits, the programmable interface/control board 102/200 may sense the closure of wash service relays, for example.

During use, the pay station 103/206 generates a randomly unique PIC or identifies a predefined PIC based on the wash package-promotion selected and presents this PIC on the digital display 217 for the customer and to the customer's smart device user interface via short range wireless signals 500. Thereby, differentiated from a typical market push through model, in certain embodiments, a transaction pull through model including downloadable web links for applications and the like defines this embodiment. Simultaneous to this, the PICs are wirelessly distributed to select devices: at least one product vendor device 219 and/or at least one self-service device 221, each coupled to wireless keypad 220 and 222, which are integrated with the coin mechanisms of the respective devices. Such distribution to product vendor devices 219 and self-service devices 221 may be via long range wireless signals. This would be achieved by adding a wireless module to the interface control board and attaching a wireless receiver and sender to the product/service vendor(s), which would enable a pulse to be received by the vendor to generate the applicable dispenses and/or credits. This would allow the operator to either take advantage of existing/current locations of venders and/or provide additional flexibility to install them where needed with minimal installation expenses. Customer enters a valid PIC to trigger the device operation. Used and expired PICs are wirelessly returned to the programmable interface 102 control board 200 for processing.

Upon the purchase of the wash packages or wash time output signals are sent to the programmable interface 102 control board 200, which then communicates (wired or wirelessly) with the intended product or service devices based on the device-specific program the operator provided, which will determine product or service eligibility, which could range from free or discount products or services depending on the level of eligibility.

The typical inputs required to drive the above logic is: Carwash package selected (switch closures); Time Purchased (pulses); and other digital Inputs; manually entered PICs; PIC Credits Configured Based on certain Wash Packages; PIC Durations Configured Based on certain Wash Packages; PIC Expiration Timing Configured; PIC Deletion Timing Configured; PIC-Device Association; PIC Entry into Device; Pulses Passed/Triggered to Device Coin Mechanism; PIC Deactivation; PIC Deletion; PIC Cancelation; and PIC Return.

The typical outputs required to drive the above logic is: Interface Control Board Output; Pulses to product device venders (conditioned as required for each vender); Pulses to service device venders (conditioned as required for each device); Device related reporting to capture number of transactions and redemption rates for respective services. Reports can be configurable and enhanced based on user's needs; Random Generation of Unique PIC Associated to Wash Package and Programmed Promotion Offerings; PIC Display on Digital Readout; Wireless Distribution of PIC (promotion offerings) to Targeted Devices, including customer's smart device. The lighted Indicator Button may blink in a predefined sequence based on eligibility or service condition. If any fault occurs during the sales transaction, the Lighted Indicator Button (108) may blink based on the fault/service condition incurred to let the operator know that service is required (e.g., low hopper, empty hopper, jammed hopper, etc.).

The method of using the present invention may include the following. The system disclosed above may be provided. The operator may program in the various promotions for all devices/venders integrated into the carwash POS system in terms of the number of credits or dispenses each device/vendor will receive based on the wash package selected. The programmed promotions can be simulated offline to ensure they are functioning as intended.

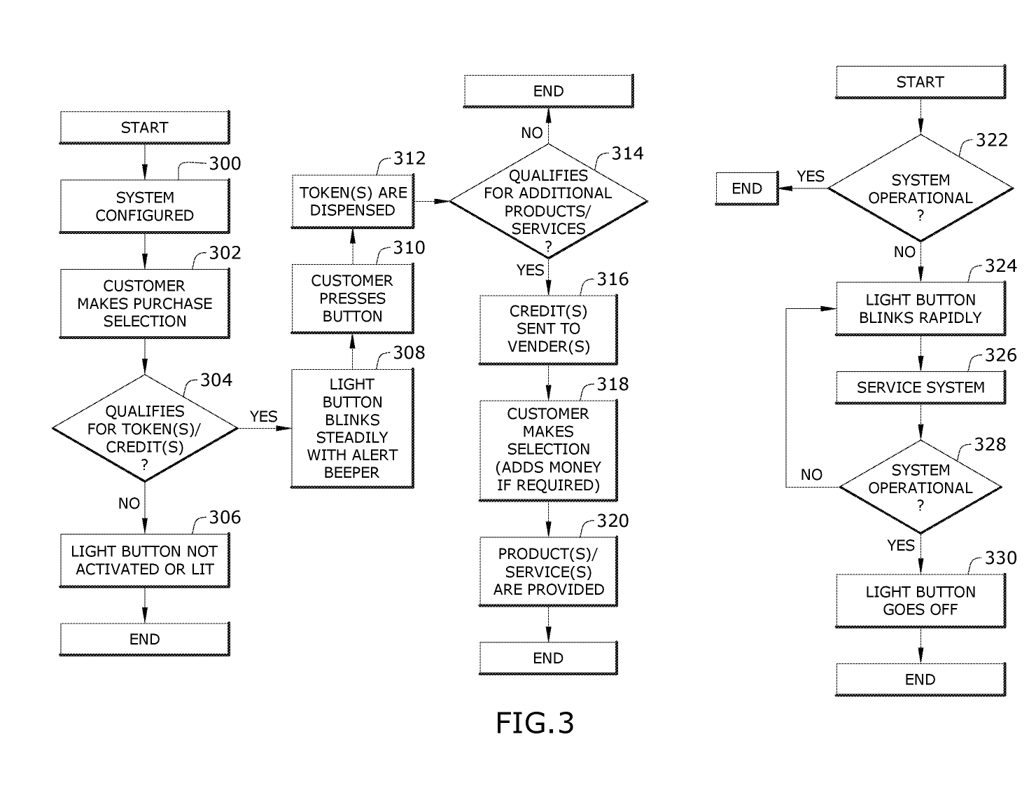

Referring to FIG. 3, in operation, when the customer approaches the automatic car wash service pay station 103/206, they will select a wash package or pay for a specified amount of time in the case of a self-serve car wash pay station 302. Once the wash package has been purchased (automatic car wash) pay station or the total amount of purchase time has been reached (self-serve) pay station, the interface control board will determine what offerings to provide the customer based on how the operator has programmed the interface controller 304.

If the customer does not qualify for a token, the lighted button will remain deactivated and unlit 306. However, if the customer does qualify for the token(s), the lighted button will start blinking steadily, indicating to the customer they qualify for the token(s) 308. The customer then has the option of pushing the lighted button 310 and the token(s)/coin(s) are dispensed 312 by the token hopper. If a vendor is interfaced to the control board and the customer qualifies for additional free products or services 314, a credit will be sent to the appropriate product vender or service vendor 316. When the customer presses the button on the respective vendor(s), their free item/service will dispense/activate 320 if qualified. The level of qualification will be determined by the interface control board and how the operator has chosen to establish their promotions. If the customer qualified for a discounted product, they would have to add additional money as required prior to receiving their product and/or service 318. Prior to every transaction, the system will check to see if it's operational for the next customer 322. If it is not, the lighted button will start blinking rapidly 324, indicating to the operator that a service condition exists. The operator would then attempt to fix it 326 and, when corrected, the lighted button will go off 330.

From a digital perspective, configure the system to execute desired promotions based on the wash package selected 402. Enter wash and admin PICs into the system to be used for providing wash package discounts and for giving to customers for appeasement, respectively 404. Admin PICs are then wirelessly distributed 406 to wireless key pads for storage 408.

Customer makes purchase 410 and a system determines if they qualify for a promotion 412, 419. If they qualify, a unique PIC is generated by the system 416 and displayed to the customer 418 and sent digitally to their smart device via signal 500, wherein the PIC display may be accompanied by an alert beep. Simultaneous to this, the PIC is wirelessly distributed 420 to the target device(s) keypad and stored 422. PICs have a specified duration when if exceeded will be deactivated 424 and wirelessly returned 426 back to the control board 200 where it will be deleted after a specified period of time and then be eligible for regeneration.

Customer may enter their PIC obtained at the pay station into the wireless keypad 428 where it is validated by the system 430 and rejected if not valid 432. If valid, the device will be initiated 434. Once the PIC is used, it will be wirelessly returned 436 back to the control board 100 and deactivated and ultimately deleted where it will be eligible for regeneration.

If a customer has a service issue/request while on site, they can contact the company 438 where the company can provide Admin PIC so the customer can enter this PIC into the wireless keypad 442 initiate the device immediately 444. This used PIC will be wirelessly sent back to the control board 200 where it will be deactivated and eventually delete where it will be eligible for regeneration.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent that the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for controlling an unattended service station having at least one self-service device, comprising:
each self-service device comprising:
a keypad to input at least one PIC; and
a database for storing a plurality of PICs,
wherein each self-service device is configured to initiate upon matching an inputted PIC with a stored PIC;
at least one pay station coupled to each self-service device, the at least one pay station configured to generate PICs and to prompt a consumer for at least one received qualification; and
a programmable interface coupled to the at least one pay station, wherein the programmable interface prompts a user to set at least one promotion and associate at least one predetermined qualification and at least one self-service device of the plurality of self-service devices with each promotion,
wherein each pay station is configured to transmit a PIC to each self-service device and customer's smart device associated with each matched promotion of the at least one promotion that is associated with said at least one predetermined qualification matching the at least one received qualification.

2. The system of claim 1, wherein the at least one self-service device comprises at least one product device or at least one self-service device configured to receive a predetermined number of tokens prior to initiation.

3. The system of claim 2, wherein the at least one pay station includes automatic pay station and or a self-serve pay station, wherein each self-serve pay station is based on time of use of at least one of the at least one self-service device, and wherein each automatic pay station is configured to dispense tokens.

4. The system of claim 1, wherein the programmable interface is coupled to the at least one self-service devices for transmitting a PIC thereto during a customer issue.

5. The system of claim 4, wherein the at least one self-service device is configured to transmit inputted PIC to the programmable interface for deactivation.

6. The system of claim 3, wherein each automatic pay station provides a token hopper coupled to the programmable interface.

7. The system of claim 6, wherein the programmable interface is configured to prompt the user to associate an amount of tokens to be dispensed through the token hopper for each matched promotion.

8. A system for controlling an unattended service station having a plurality of self-service devices, comprising:
at least one token self-service device configured to receive a predetermined number of tokens prior to initiation;
at least one digital self-service devices comprising:
a keypad to input at least one PIC; and
a database for storing a plurality of PICs,
wherein each self-service device is configured to initiate upon matching an inputted PIC with a stored PIC;
a plurality of pay stations coupled to each self-service device, each pay station configured to prompt a consumer for at least one received qualification;
each pay station configured to either to generate PICs or dispense tokens through an attached token hopper; and
a programmable interface coupled to each pay station, wherein the programmable interface prompts a user to set at least one promotion and associate at least two of:
at least one predetermined qualification;
at least one self-service device of the plurality of self-service devices with each promotion; and
a predetermined number of tokens to be dispensed through the token hopper for each matched promotion,
wherein the programmable interface is coupled to each digital self-service devices for transmitting a PIC thereto during a customer issue, and
wherein each pay station generating PICs is configured to transmit each PIC to each digital self-service device associated with each matched promotion of the at least one promotion that is associated with said at least one predetermined qualification matching the at least one received qualification, and wherein the plurality of self-service devices is configured to transmit inputted PIC to the programmable interface for deactivation.
